(19) United States
(12) Patent Application Publication
(10) Pub. No.: US 2002/0004835 A1
(43) Pub. Date: Jan. 10, 2002

(54) Message queue server system

(75) Inventor: Graham G. Yarbrough, Sandy Hook, CT (US)

Correspondence Address: PEPPER HAMILTON, 600 FOURTEENTH STREET NW, WASHINGTON, DC, 20005, US

(73) Assignee: INRANGE Technologies Corporation, Lumberton, NJ (US)

(21) Appl. No.: 09/872,756

(22) Filed: Jun. 1, 2001

Related U.S. Application Data
(60) Provisional application No. 60/209,173, filed on Jun. 2, 2000.
(60) Provisional application No. 60/209,054, filed on Jun. 2, 2000.

(51) Int. Cl. G06F 15/16

(52) U.S. Cl. 709/230; 709/206

(57) ABSTRACT

A message queue server emulates a computer peripheral that not only supports communication between two mainframes, but also provides a gateway to open systems computers, networks, and other similar message queue servers. The message queue server provides protocol-to-protocol conversion from mainframes to today's computing systems in a manner that does not require businesses that own the mainframes to rewrite legacy applications to share data with other mainframes and open systems. The message queue server emulates a mainframe peripheral coupled to a first mainframe having a first protocol. The system includes digital storage to temporarily store information from the first mainframe. The system includes at least one manager that (i) coordinates the transfer of the information of the first protocol between the mainframe peripheral emulator and the digital storage and (ii) coordinates transfer of the information between the digital storage and (a) a second mainframe having a second protocol or (b) a computer network having a third protocol. Preferably, the message queue server emulates a tape drive and arranges the stored messages in a queue. Optionally, the message queue server manages the message queues as a function of information usually found in a standard tape label.

### RELATED APPLICATION(S)

This application claims the benefit of U.S. Provisional Application No. 60/209,173, filed Jun. 2, 2000, entitled “Message Director,” by Yarbrough; U.S. Provisional Patent Application No. 60/209,054, filed Jun. 2, 2000, entitled “Enhanced EET-3 Channel Adapter Card,” by Haulund et al.; and related to co-pending U.S. Patent Application, filed concurrently herewith, Attorney Docket No. 2997.1002-001, entitled “Enhanced Channel Adapter,” by Haulund et al.; the entire teachings of all are incorporated herein by reference.

### BACKGROUND OF THE INVENTION

Today's computing networks, such as the Internet, have become so widely used, in part, because of the ability for the various computers connected to the networks to share data. These networks and computers are often referred to as “open systems” and are capable of sharing data due to commonality among the data handling protocols supported by the networks and computers. For example, a server at one end of the Internet can provide airline flight data to a personal computer in a consumer's home. The consumer can then make flight arrangements, including paying for the flight reservation, without ever having to speak with an airline agent or having to travel to a ticket office. This is but one scenario in which open systems are used.

One type of computer system that has not “kept up with the times” is the mainframe computer. A mainframe computer was at one time considered a very sophisticated computer, capable of handling many more processes and transactions than the personal computer. Today, however, because the mainframe computer is not an open system, its processing abilities are somewhat reduced in value since legacy data that are stored on tapes and read by the mainframes via tape drives are unable to be used by open systems. In the airline scenario discussed above, the airline is unable to make the mainframe data available to consumers.

FIG. 1 illustrates a present day environment of the mainframe computer. The airline, Airline A, has two mainframes, a first mainframe 100a (Mainframe A) and a second mainframe 100b (Mainframe B). The mainframes may be in the same room or may be separated by a building, city, state or continent.

The mainframes 100a and 100b have respective tape drives 105a and 105b to access and store data on data tapes 115a and 115b corresponding to the tasks with which the mainframes are charged. Respective local tape storage bins 110a and 110b store the data tapes 115a, 115b.

During the course of a day, a technician 120a servicing Mainframe A loads and unloads the data tapes 115a. Though shown as a single tape storage bin 110a, the tape storage bin 110a may actually be an entire warehouse full of data tapes 115a. Thus, each time a new tape is requested by a user of Mainframe A, the technician 120a retrieves a data tape 115a and inserts it into tape drive 105a of Mainframe A.

Similarly, a technician 120b services Mainframe B with its respective data tapes 115b. In the event an operator of Mainframe A desires data from a Mainframe B data tape 115b, the second technician 120b must retrieve the tape and send it to the first technician 120a, who inserts it into the Mainframe A tape drive 105a. If the mainframes are separated by a large distance, the data tape 115b must be shipped across this distance and is then temporarily unavailable by Mainframe B.

FIG. 2 is an illustration of a prior art channel-to-channel adapter 205 used to solve the problem of data sharing between Mainframes A and B that reside in the same location. The channel-to-channel adapter 205 is in communication with both Mainframes A and B. In this scenario, it is assumed that Mainframe A uses an operating system having a first protocol, protocol A, and Mainframe B uses an operating system having a second protocol, protocol B. It is further assumed that the channel-to-channel adapter 205 uses a third operating system having a third protocol, protocol C.

The adapter 205 negotiates communications between Mainframes A and B. Once the negotiation is completed, the Mainframes A and B are able to transmit and receive data with one another according to the rules negotiated.

In this scenario, all legacy applications operating on Mainframes A and B have to be rewritten to communicate with the protocol of the channel-to-channel adapter 205. The legacy applications may be written in relatively archaic programming languages, such as COBOL. Because many of the legacy applications are written in older programming languages, the legacy applications are difficult enough to maintain, let alone upgrade, to use the channel-to-channel adapter 205 to share data between the mainframes.

Another type of adapter used to share data among mainframes or other computers in heterogeneous computing environments is described in U.S. Pat. No. 6,141,701, issued Oct. 31, 2000, entitled “System for, and Method of, Off-Loading Network Transactions from a Mainframe to an Intelligent Input/Output Device, Including Message Queuing Facilities,” by Whitney. The adapter described by Whitney is a message oriented middleware system that facilitates the exchange of information between computing systems with different processing characteristics, such as different operating systems, processing architectures, data storage formats, file subsystems, communication stacks, and the like. Of particular relevance is the family of products known as “message queuing facilities” (MQF). Message queuing facilities help applications in one computing system communicate with applications in another computing system by using queues to insulate or abstract each other's differences. The sending application “connects” to a queue manager (a component of the MQF) and “opens” the local queue using the queue manager's queue definition (both the “connect” and “open” are executable “verbs” in a message queue series (MQSeries) application programming interface [API]). The application can then “put” the message on the queue.

Before sending a message, an MQF typically commits the message to persistent storage, typically to a direct access storage device (DASD). Once the message is committed to persistent storage, the MQF sends the message via the communications stack to the recipient's complementary and remote MQF. The remote MQF commits the message to persistent storage and sends an acknowledgment to the sending MQF. The acknowledgment back to the sending queue manager permits it to delete the message from the sender's persistent storage. The message stays on the remote MQF's persistent storage until the receiving application indicates it has completed its processing of it. The queue definition indicates whether the remote MQF must trigger the receiving application or if the receiver will poll the queue on its own. The use of persistent storage facilitates recoverability. This is known as “persistent queue.”

Eventually, the receiving application is informed of the message in its local queue (i.e., the remote queue with respect to the sending application), and it, like the sending application, “connects” to its local queue manager and “opens” the queue on which the message resides. The receiving application can then execute “get” or “browse” verbs to either read the message from the queue or just look at it.

When either application is done processing its queue, it is free to issue the “close” verb and “disconnect” from the queue manager.

The persistent queue storage used by the MQF is logically an indexed sequential data set file. The messages are typically placed in the queue on a first-in, first-out (FIFO) basis, but the queue model also allows indexed access for browsing and the direct access of the messages in the queue.

Though MQF is helpful for many applications, current MQF and related software utilize considerable mainframe resources. Moreover, modern MQF's have limited, if any, functionality allowing shared queues to be supported.

Another type of adapter used to share data among mainframes or other computers in heterogeneous computing environments is described in U.S. Pat. No. 5,906,658, issued May 25, 1999, entitled “Message Queuing on a Data Storage System Utilizing Message Queueing in Intended Recipient's Queue,” by Raz. Raz provides, in one aspect, a method for transferring messages between a plurality of processes that are communicating with a data storage system, wherein the plurality of processes access the data storage system by using I/O services. The data storage system is configured to provide a shared data storage area for the plurality of processes, wherein each of the plurality of processes is permitted to access the shared data storage region.

### SUMMARY OF THE INVENTION

In U.S. Pat. No. 6,141,701, Whitney addresses the problem that current MQF (message queuing facilities) and related software utilize considerable mainframe resources and costs associated therewith. By moving the MQF and related processing from the mainframe processor to an I/O adapter device, the I/O adapter device performs a conventional I/O function, but also includes MQF software, a communications stack, and other logic. The MQF software and the communications stack on the I/O adapter device are conventional.

Whitney further provides logic effectively serving as an interface to the MQF software. In particular, the I/O adapter device of Whitney includes a storage controller that has a processor and a memory. The controller receives I/O commands having corresponding addresses. The logic is responsive to the I/O commands and determines whether an I/O command is within a first set of predetermined I/O commands. If so, the logic maps the I/O command to a corresponding message queue verb and queue to invoke the MQF. From this, the MQF may cooperate with the communications stack to send and receive information corresponding to the verb.

The problem with the solution offered by Whitney is similar to that of the adapter 205 (FIG. 2) in that the legacy applications of the mainframe must be rewritten to use the protocol of the MQF. This causes a company, such as an airline, that is not in the business of maintaining and upgrading legacy software to expend resources upgrading the mainframes to work with the MQF to communicate with today's open computer systems and to share data even among their own mainframes, which does not address the problems encountered when mainframes are located in different cities.

The problem with the solution offered in U.S. Pat. No. 5,906,658 by Raz is, as in the case of Whitney, legacy applications on mainframes must be rewritten in order to allow the plurality of processes to share data.

The present invention addresses the issue of having to rewrite legacy applications in mainframes by using the premise that mainframes have certain peripheral devices. For example, mainframes have tape drives, and, consequently, the legacy applications operating on the mainframes have the ability to read and write from tape drives. Therefore, the present invention addresses the problems and shortcomings of the prior art systems by providing a message queue server that emulates a tape drive that not only supports communication between two mainframes, but also provides a gateway to open systems computers, networks, and other similar message queue servers. In short, the principles of the present invention provide protocol-to-protocol conversion from mainframes to today's computing systems in a manner that does not require businesses that own the mainframes to rewrite legacy applications to share data with other mainframes and open systems.

One aspect of the present invention is a system for protocol conversion. The system includes a device emulator coupled to a first device, such as a mainframe computer, having a first protocol. The system includes digital storage to temporarily store information from the first protocol. The system also includes at least one manager that (i) coordinates the transfer of the information of the first protocol between the device emulator and the digital storage and (ii) coordinates transfer of the information between the digital storage and a device having a second protocol.

Preferably, the device emulator is a tape drive emulator. Typically, the information is arranged in a queue in the digital storage.

Another aspect of the present invention includes a manager for protocol conversion. The system includes at least one I/O manager having intelligence to support states of emulation devices transceiving messages using a first protocol and an interface transceiving messages using a second protocol. The system includes at least one emulation device providing low-level control reaction to an external device adhering to the first protocol. At least one group driver is included to provide an interface between the I/O manager and the emulation device(s). In one embodiment, the emulation device emulates a tape drive.

Yet another aspect of the present invention is a system for mainframe-to-mainframe connectivity. The system emulates a computer peripheral that is in communication with a first mainframe. The first device emulator acts as a standard sequential storage device. The system also includes a second device emulator in communication with a second mainframe. The second device emulator also acts as a standard sequential storage device. Digital storage is coupled to the first and second device emulators to store information temporarily for the first and second device emulators. The system also includes at least one manager that (i) coordinates a first transfer of information between the first device emulator and the digital storage and (ii) coordinates a second transfer of information from the digital storage to the second device emulator. The first and second mainframes have access to the information via respective device emulators. In one embodiment, the information stored in the digital storage is arranged in a queue.

Yet another aspect of the present invention includes a method and apparatus for managing messages in a data storage system. The data storage system receives information that is normally contained in a standard tape label. Based on the information, a controller applies the information to a non-tape memory designated for a message queue. The controller stores messages related to the information in the memory. The controller also manages the message queue as a function of the standard tape label information. Examples of standard tape label information that is acted on by the controller include: volume serial number, data set name, expiration date, security attributes, and data characteristics.

The various aspects of the present invention can be used in a network environment. For example, data sharing between mainframes connected to the emulators, (e.g., tape drive emulators) can be located in a closed network containing two mainframes and the emulator protocol-to-protocol conversion system, where messages are transferred from one mainframe to the other mainframe by transferring messages to the memory supporting the emulators en route to the other mainframe.

In a larger networking environment, the mainframes need not be in a closed network. In such a networking environment, the system includes a device emulator connecting to the mainframes, processor for executing software servicing message queues, memory for storing the message queues, and a network interface card, such as a TCP/IP interface card connecting to a TCP/IP network to transfer the messages in a packetized manner from the first mainframe to at least one other mainframe. In other words, once the messages are in the memory supporting the device emulators, the messages can be transferred to other memories supporting other device emulators via any middleware interface, commercial or customized, to transfer the messages to the other mainframe(s). Alternatively, the messages can be transferred to any open system computer or computer network.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is an illustration of an environment in which mainframe computers are used with computer tapes to share data among the mainframe computers;

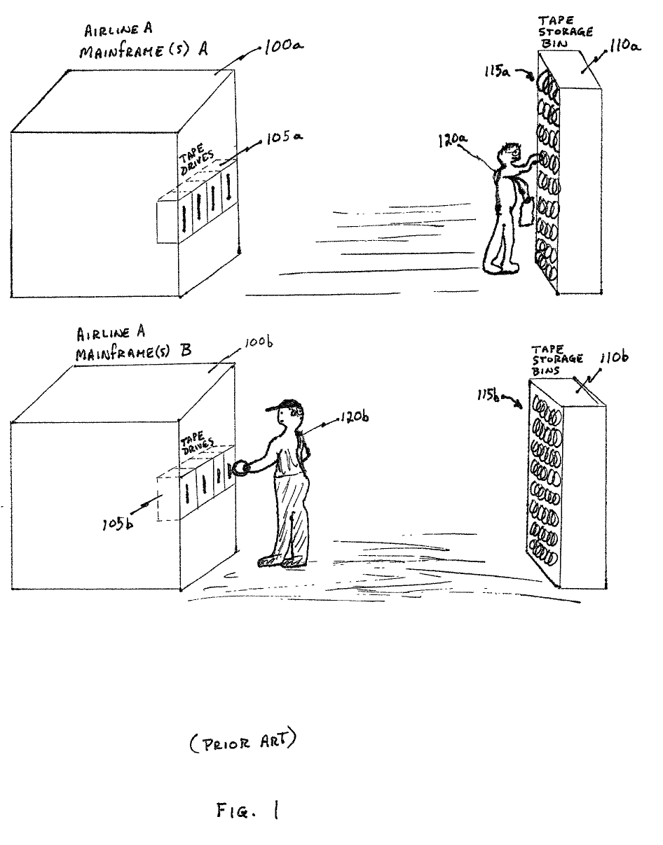

FIG. 2 is a block diagram of a prior art solution to sharing data between mainframes without having to physically transport tapes between the mainframes, as in the environment of FIG. 1;

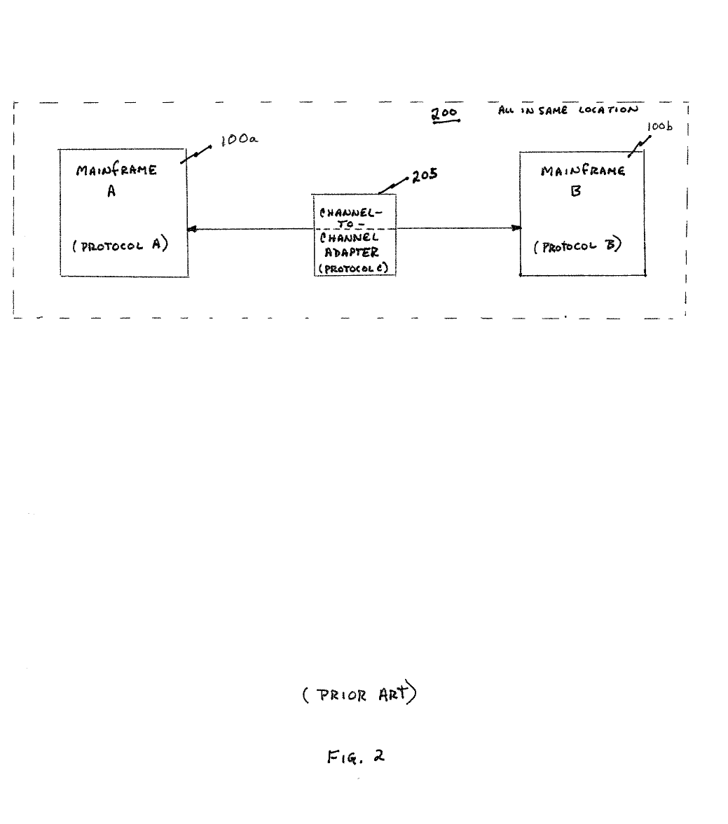

FIG. 3 is a block diagram in which a mainframe is able to share data with an open system computer network via a queue server according to the principles of the present invention;

FIG. 4 is a detailed block diagram of the queue server of FIG. 3;

FIG. 5 is a block diagram of an I/O manager, employed by the queue server of FIG. 4, having a device table database;

FIG. 6 is an illustration of an environment in which the queue server of FIG. 3 is used by mainframes to share data; and

FIG. 7 is a block diagram of an environment in which mainframes are able to share data with other mainframes via the queue server of FIG. 3 over long distances through the use of wide area networks.

### DETAILED DESCRIPTION OF THE INVENTION

A description of preferred embodiments of the invention follows.

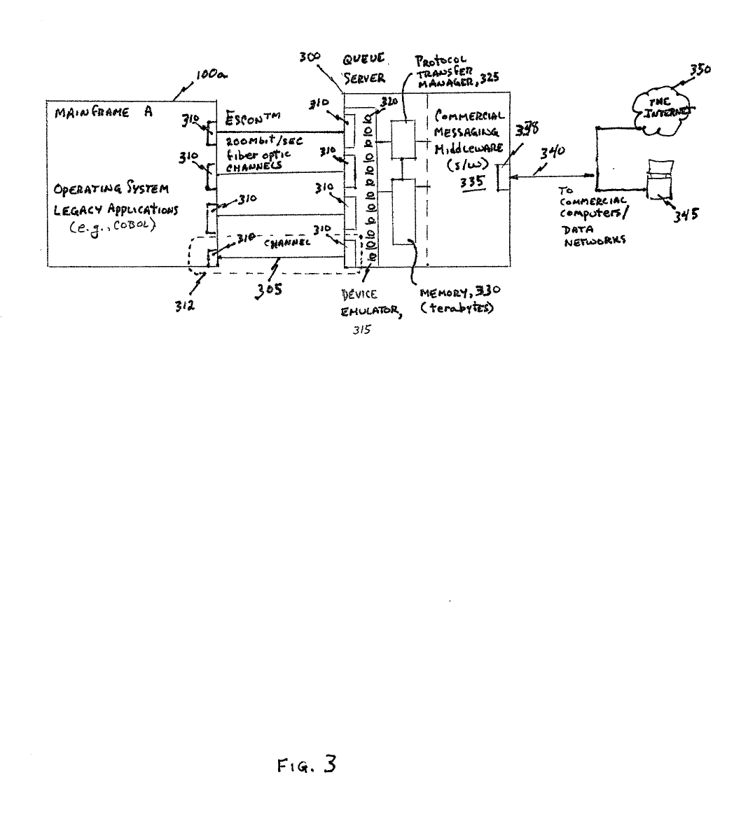

FIG. 3 is a block diagram of a mainframe 100a (Mainframe A) in communication with a queue server 300 employing the principles of the present invention. The queue server 300 is in communication with a computer network 350 (e.g., the Internet) and an open system computer 345.

Mainframe A has an operating system and legacy applications, such as applications written in COBOL. The operating system and legacy applications are not inherently capable of communicating with todays open systems computer networks and computers. Mainframe A, however, does have data useful to open systems and other mainframes (not shown), so the queue server 300 acts as a transfer agent between Mainframe A and computers connected to the open systems computer networks and computers.

To transfer data between Mainframe A and the queue server 300, Mainframe A provides data to a channel 312. The channel 312 includes three components: a communication link 305 and two interface cards 310, one located at Mainframe A and the other at the queue server 300. The interface card 310 located in the queue server may support block message transfers and non-volatile memory, as described in U.S. Provisional Patent Application No. 60/209,054, filed Jun. 2, 2000, entitled “Enhanced EET-3 Channel Adapter Card,” by Haulund et al. and co-pending U.S. Patent Application, filed concurrently herewith, entitled “,” by Haulund et. al., the entire teachings of both are incorporated herein by reference. Mainframe A also receives information from the queue server 300 over the same channel 312. The channel 312 is basically transparent to Mainframe A and the queue server 300.

Mainframes, such as Mainframe A, have traditional device peripherals that support the mainframes. For example, mainframes are capable of communicating with printers and tape drives. That means that the applications running on the operating system on Mainframe A have the “hooks” for communicating with a printer and tape drive. The queue server 300 takes advantage of this commonality among mainframes by providing an interface to the legacy applications with which they are already familiar. Here, the queue server 300 has a device emulator 315 that serves as a transceiver with the legacy applications via the channels 312. Thus, rather than “reinventing the wheel” by providing a MQF (message queue facility) that is a stand-alone device and requires legacy applications to be rewritten to communicate with them, the queue server 300 emulates a peripheral known to mainframes.

In one embodiment, the device emulator 315 is composed of multiple tape drive emulators 320. In actuality, the tape drive emulators 320 are merely software instances that interact with the interface cards 310. The tape drive emulators 320 provide low-level control reactions that adhere to the stringent timing requirements of traditional commercial tape drives that mainframes use to read and write data. In this way, the legacy applications are under the impression that they are simply reading and writing data from and to a tape drive, unaware that the data is being transferred to computers using other protocols.

In practice, the data received by the tape drive emulators 320 are provided to memory 330, as supported by a protocol transfer manager 325. Once in memory 330, the data provided by the legacy applications are then capable of being transferred to commercial messaging middleware 335.

The commercial messaging middleware 335 is also supported by the protocol transfer manager 325, which supports read/write transactions of the commercial messaging middleware 335 with the memory 330 and higher-level administrative activities.

The commercial messaging middleware 335 interfaces with an interface card 338, such as a TCP/IP interface card, that connects to a modern computer network, such as the Internet 350, via any type of network line 340. For example, the network line 340 could be a fiber optic cable, local area network cable, wireless interface, etc. Further, a desktop computer 345 could be directly coupled to the commercial messaging middleware 338 via the network line 340 and TCP/IP interface card 338.

In effect, the queue server 300 is solving the problem of getting data from mainframes into a standard, commercial environment that is easily accessed by today's commercial programs. The commercial programs may then use the data from the mainframes to publish, filter, or transform the data for later use by, for example, airline representatives, agents, or consumers who wish to access the data for flight planning or other reasons.

The queue server 300 may also act as an interface between various operating systems of mainframes. For example, a TPF (transaction processing facility) mainframe operating system used for reservations and payment transactions can transfer the TPF data to a mainframe using a VM (virtual machine) mainframe operating system or to a mainframe using the MVS (multiple virtual storage) mainframe operating system. The queue server 300 allows data flow between the various mainframes by temporarily storing data in messages in persistent message queues in the memory 330. In other words, the memory 330 is not intended as a permanent storage location as in the case of a physical reel tape, but will retain the messages containing the data until instructed to discard them.

The messages stored in the memory 330 are typically arranged in a queue in the same manner as messages are stored on a tape drive because the legacy systems are already programmed to store the data in that manner. Therefore, the legacy applications on the mainframes do not need to be rewritten in any way to transmit and receive data from the memory 330. The queue is logically an indexed sequential data set file, which may also use various queuing models, such as first-in, first out (FIFO); last-in, first out (LIFO); or priority queuing models. It should be understood that the memory 330 is very large (e.g., terabytes) to accommodate all the data that is usually stored on large computer tapes.

The data exchange between the mainframes can be done in near real-time or non-real time, depending on the length of the queue. For example, if the queue storing the messages has a length of one message, then the data exchange is near-real-time since the message is forwarded to the receiving mainframe once the queue is full with the one message. If the length of the queue is several hundred messages, then data from a first mainframe is written until the queue is filled, and then the data is transferred to the second mainframe in a typical tape drive-to-mainframe manner. The channel 312 typically transfers messages on a message-by-message basis. The memory 330, however, allows storage of many messages at a time, which allows the protocol transfer manager 325 to configure the tape drive emulators 320 in a mode supporting direct memory access (DMA) transfer of messages to improve data flow in the emulator-to memory link of the data flow.

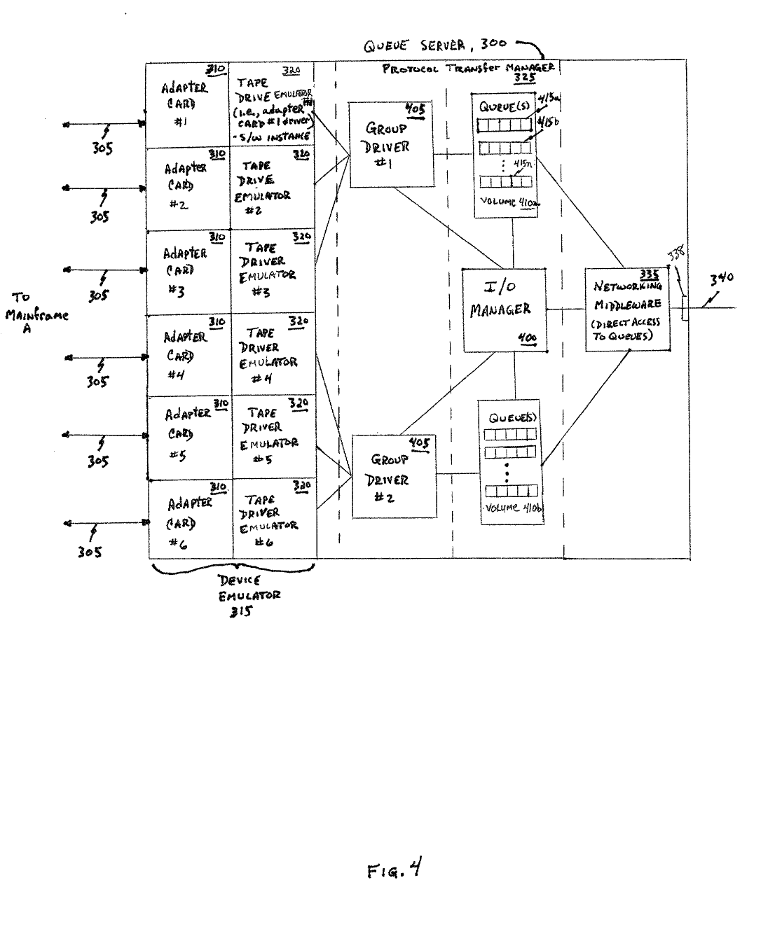

FIG. 4 is a detailed block diagram of the queue server 300. The queue server 300 has (i) a front-end that includes adapter cards 310 and tape drive emulators 320, (ii) a protocol transfer manager 325 that include software processes, and (iii) a back-end that includes networking middleware 335 and network interface card 228, where the networking middleware 335 is connected to a network line 340 via the network interface card 338.

Referring first to the front-end of the queue server 300, the adapter cards 310 and tape drive emulators 320 compose a device emulator 315. As shown, a single tape drive emulator 320 is coupled to and supporting a single adapter card 310. However, because the tape drive emulator 320 is embodied as one or more software instances, there can be many tape drive emulators connecting to a single adapter card 310, and vise-versa. The tape drive emulator 320 and I/O manager 400 support the standard, channel command words provided by legacy applications operating on a mainframe, such as Mainframe A. For example, the channel command words include read, write, mount, dismount, and other tape drive commands that are normally used to control a tape drive. In an alternative embodiment, the tape drive emulators 320 emulate a different mainframe peripheral device; in that case, the tape drive emulators 320 support a different, respective, set of command words provided by the legacy applications for communicating with that different mainframe peripheral device.

Referring next to the protocol transfer manager 325 of the queue server 300, located between I/O manager 400 and the tape drive emulators 320 is at least one group driver 405. The group drivers 405 are also software instances, as in the case of the tape drive emulators 320. The group drivers 405 are intended to off-load some of the processing required by the I/O manager 400 so that the I/O manager does not have to interface directly with each of the tape drive emulators 320. Each group driver 405 provides interface support for one or more associated tape drive emulator(s) 320 and the I/0 manager 400. The group drivers 405 multiplex signals from the number of tape drive emulators 320 with which they are associated. Because the group drivers 405 are software instances, any number of group drivers 405 can be provided to support the tape drive emulators 320. Similarly, because the I/O manager 400 is a software instance, there can be many I/O managers 400 operating in the queue server 300. Thus, the protocol transfer manager 325 can be configured to provide parallel processing functionality for the mainframes and open systems being serviced.

It should be understood that the queue server 300 is composed of electronics that include computer processors on which the I/O manager 400, group drivers 405, tape drive emulators 320, and commercial messaging middleware 335 are executed. There may be several processors for parallel or distributed processing. The queue server 300 also includes other circuitry to allow the computer processors to interface with the adapter cards 310, memory 330, and TCP/IP interface card 338. The queue server 300 may include additional memory (not shown), such as RAM, ROM, and/or magnetic or optical disks to store the software listed above. The memory, both for the software and the queues is preferably local to the queue server 300, but may be remote and accessed over a local area network or wide area network. In the case of the queues, the delay in accessing the memory will cause additional latency in transferring the messages, but will not affect the interaction with the mainframes that require rapid response to requests since the tape drive emulators 320 handle that function.

Within the memory 330, the messages are stored as queues 415a, 415b, . . . , 415n (collectively 415) in a volume 410, as in the case of a standard tape. The queues 415 are managed by using information that is normally contained in a standard tape label. For example, to build the queue name, the volume serial number and data set name is used in one embodiment. Another piece of data that is normally contained in a standard tape label is an expiration date, which allows the I/0 manager 400 to decide how long to retain the message queue 415 in the memory 330. Security attributes found in a standard tape label are used by the I/0 manager 400 to apply security attributes to the messages in the respective queues 415.

Other information contained in the standard tape label may be used by the I/0 manager 400 to optimize the messages in the queue based on the data characteristics of the messages. Mounting the queue, which is done by selecting the pointer (i.e., software pointer storing the hexadecimal memory location) pointing to the head of the queue, is performed by the I/O manager 400 based on receiving a volume ID or data set name request message from the Mainframe A. It should be understood that the management features based on the standard tape label information just provided is merely exemplary of the types of actions that can be performed by the I/0 manager 400 in managing the queues. Another feature, for example, is a tape mark action that marks an indicator within the associated message queue.

In operation, Mainframe A provides many commands to the queue server 300 for handling messages in queues. These commands are typical of communication with a real tape drive, but here, the tape drive emulators 320 receive the commands and either (i) provide fast response to Mainframe A in response to those commands or (ii) allow the commands to pass unfettered to the I/O manager 400 for administrative non-real-time processing. The following discussion provides write and read operations that occur during typical interaction between Mainframe A and the queue server 300.

Mainframe WRITE operation—scratch tape

Assuming the MVS Operating System is running Mainframe A, the Tape Volume Id is specified on a JCL (Job Control Library), which runs the job in question. Mainframe A initiates the tape operation by sending an LDD CCW (Load Display Device Channel Command Word), which identifies the specific tape to be mounted and the “device” on which to mount it. From the point of view of the Mainframe A, the “device” is a tape drive, which is being emulated by the tape drive emulator 320. This CCW (i.e., the ‘command’ sent on the channel 312) is received by the channel-to-channel adapter card 310 and intercepted by the tape drive emulator 320. The tape drive emulators 320 then sends notice to the group driver 405 via an interdriver control message (MOUNT_REQUEST_RECEIVED), which contains the information sent via the channel 312. In one embodiment, there is one message path between the tape driver 320 and the group driver 405 over which messages relating to the adapters cards 310 travel (i.e., the message path is multiplexed).

The group driver 405 receives the message, determines its ultimate destination (i.e., the individual application or thread controlling the specific tape drive emulator 320 and queue 415), and places the message into a control message for delivery to the I/O manager 400, where the I/O manager 400 is the major component of the protocol transfer manager 325, also referred to as a SMART (system for message addressing routing and translation).

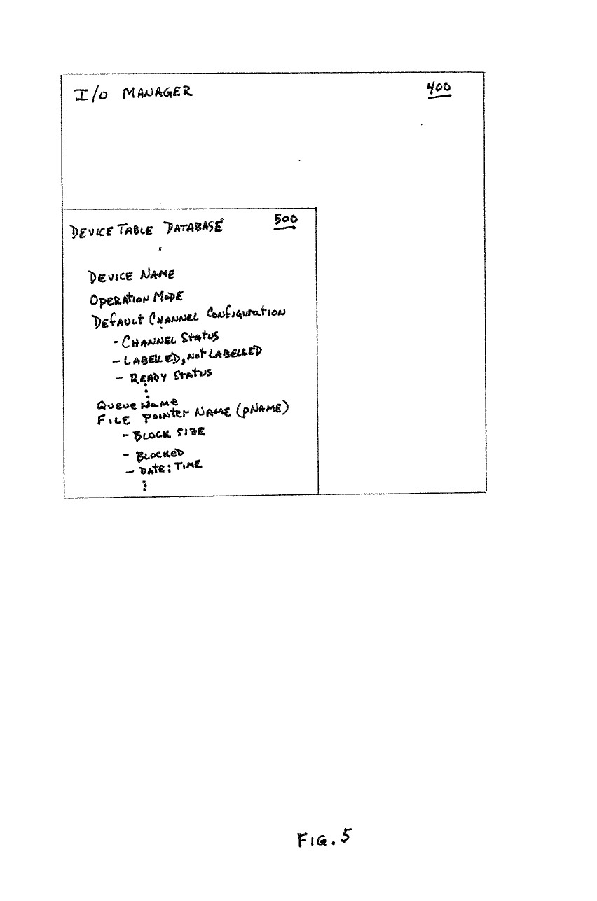

The I/O manager 400 uses the Tape VolumeId contained in the message to ‘lookup’ the queue associated with the Tape VolumeId. The I/O manager 400 uses the Virtual Tape Library (VTL—an internal process within the queue server 300) to perform this lookup function. The VTL uses a local database, described in reference to FIG. 5, to provide a mapping between the queuing engine's (i.e., I/O manager 400 and group driver 405) data message queues 415 (not to be confused with internal interdriver queues, not shown, between the tape drive emulators 320 and group drivers 405) and the tape VolumeIds requested by the mainframe job. If the request is for a ‘scratch’ tape ID, the VTL assigns an arbitrary Id from its pool of preassigned IDs; if the request is for a specific ID, the specific ID is used. Regardless of the source, the ID is associated with a message queue (e.g., queue 415a). If the requested message queue 415a exists (i.e., the I/O manager 400 is reusing an existing queue), the requested message queue 415a is cleared of existing messages; otherwise, a new queue is created.

The queue returned is associated (sometimes referred to as ‘partnered’ or ‘married’) with the mainframe making the mount request. The I/O manager 400 then notifies the group driver 405 to ‘release’ the mainframe/channel, which has been ‘waiting’ patiently for the channel/tape drive emulator to return ‘OK’ to its mount request. The group driver 405 formats and sends an interdriver ‘release’ message to the tape driver emulator 320, which issues the necessary channel commands to release the channel 312, Mainframe A, and itself for further activity.

Mainframe A most likely next sends a tape label (three short data records containing information about the data to be written) via the channel 312 to the tape drive emulator 320. This tape label information, packaged into an interdriver message (TAPE_LABEL_RECEIVED), is intercepted by the tape drive emulator 320 and sent to the group driver 405. The group driver 405 passes this tape label information to the I/O manager 400.

The tape label information is used to ‘name’ the associated message queue 415. The tape label information is then attached to the message queue 415 in the same way that tape label information is attached to a real (i.e., physical) tape volume. The information in the tape label remains with the message queue 415a and is ‘played back’ to Mainframe A when/if the message queue 415a is read.

The I/O manager 400 notifies (‘releases’) Mainframe A by passing a message to the group driver 405, which sends the message to the tape driver 320, which notifies the channel 312, etc.

Following the release, Mainframe A begins sending data messages as if it were sending the data messages to a real tape drive. These messages are placed, under software control, directly into the main shared memory buffer pools 330 (FIG. 3) (via hardware driven DMA—Direct Memory Access, controlled by dedicated hardware, such as IBM® EET® chips residing in the channel-to-channel adapter card 310), which are visible to the queue server 300 components. Preferably, data messages are not copied; only pointers to the internal shared buffers are moved as interdriver messages between the tape drive emulator 320 and group driver 405.

Pointers to data messages are passed as interdriver messages from the tape drive emulator 320 to the group driver 405 and are queued to the correct I/O manager 400. The I/O manager 400 reads the interdriver message queue (not shown), references the data message buffer (not shown), and moves the message to the associated message queue 415a. After the queue signals to the I/O manager 400 that the message is properly safe-stored, the I/O manager 400 notifies the tape drive emulator 320, via a message to the group driver 405, to release the channel 312 to Mainframe A.

This sequence continues until Mainframe A sends a TAPEMARK (a special CCW). The tape drive emulator 320 intercepts this CCW and passes it to the I/O manager 400 as a control message via the group driver 405. After the I/O manager 400 receives the TAPEMARK, it closes the message queue 415 and disassociates it from the tape drive emulator 420.

Mainframe A next sends a trailing label followed by REWIND (and/ or UNLOAD) commands. The I/O manager is notified of the command and completes the disassociation of the tape drive emulator 320 and queue 415a. The I/O Manager 400 then recycles the tape drive emulator 320 for another mainframe request.

Mainframe READ operation

READ operations differ very little from WRITE operations. The channel/mainframe first sends a request to mount a specific tape volume (e.g., volume 410a). The volume 410a and its associated queue 415a must exist. Lookup is performed by the VTL.

Once the I/O manager 400 associates the tape drive emulator 320 with the requested queue 415a, it passes the information from the stored label to the tape drive emulator 320, which presents it to the channel 312 in response to a READ CCW. (This simulates a real tape device presenting the real tape label from the tape.)

Once Mainframe A has ‘read’ and verified the label, it sends a series of READ CCWs. These are passed to the I/O manager 400 as control messages. Each read results in the I/O manager's 400 presenting the ‘next’ data message from the queue 415a to the tape drive emulator 320 for delivery to the channel 312.

When the last message is read from the queue 415a, the I/O manager 400 notifies the tape drive emulator 320, via a WRITE_TAPEMARK control command, and the tape drive emulator 320 simulates a TAPEMARK status to the channel 312. Mainframe A then initiates ‘close’ processing during which the I/O manager 400 disassociates the queue 410a and tape drive emulator 320.

Mainframe A then sends a REWIND or UNLOAD command via the channel 312. This is passed to the I/O manager 400, which completes the tape drive emulator 320 and queue 410a disassociation.

At that time, the tape drive emulator 320 enters an idle state and is available to be associated with another queue (e.g., queue 410b).

FIG. 5 is a block diagram of the I/O manager 400 and its associated device table database 500. The device table database 500 is used to initialize various components in the queue server 300. The device table database 500 includes a device name field, operation mode field, default channel configuration, queue name, file pointer name (pName), etc. These fields are (i) representative of the types of actions executed by a real tape drive and (ii) associated with actions requested of a real tape drive. The state of the fields in the device table database 500 configure the tape drive emulator 325 for interfacing with the commands/requests from the legacy applications in Mainframe A. Timing specifications, block size, date, time, labeled/not labeled, channel status, and other relevant information specific to the mainframes, mainframe operating system, or legacy applications are stored so as to respond to signals from the adapter cards 310 in a manner expected by the channels 312 and mainframes 100. The device table database 500 may also include information for configuring the adapter cards 310. Further, the device table database may include information for interfacing with the networking middleware 335 and/or TCP/IP card 338.

The device table database 500 is typically accessed during initialization of the queue server 300. For example, the device table database 500 may specify the number of tape drive emulators 320 that are used in the queue server 300 to support the adapter cards 310, the number of group drivers supporting the I/O manager 400 in communicating with the tape drive emulators 320, and the number of I/O managers 400 used by the queue server 300. The device table database 500 may also specify the locations of the volumes 410 within the memory 330 and queues 405 within the volumes 410 (FIG. 4). It should be understood that the device table database 500 can be expanded and upgraded, as necessary.

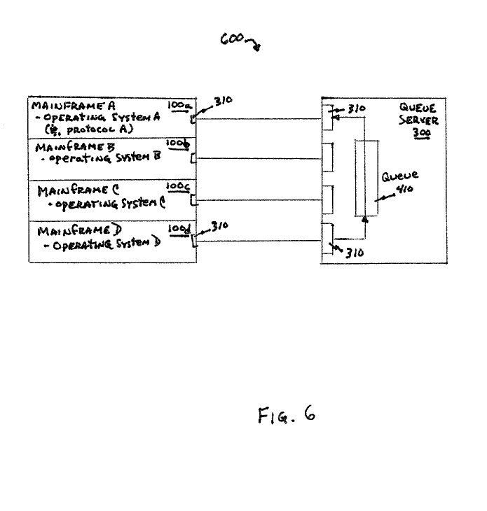

FIG. 6 is a block diagram of a closed network 600 in which the queue server 300 is used to provide protocol conversion among four mainframes. As shown, Mainframes A-D have channels coupling them to the queue server 300.

A queue 410 has been set up to store messages from Mainframe D. Following Mainframe D message storage, Mainframe A requests the messages in the queue 410.

Alternatively, Mainframe A may have requested data that the I/O manager 400 knows to be stored on a Mainframe D tape. The I/O manager may cause a message to be displayed to a technician to have the data loaded by Mainframe D and stored to a message queue 410 for retrieval by Mainframe A.

In operation, Mainframe D writes data to the queue 410 in a manner typical of writing to a tape drive. Mainframe A reads the messages in the queue 410 in a manner typical of reading from a tape in a tape drive. As described above, the I/O manager 400 (FIG. 4) and group drivers 405 (FIG. 4) support the tape drive emulators 320 during the read and write processes. Thus, protocol A operating in Mainframe A receives data from protocol D in Mainframe D without having to rewrite legacy applications in either mainframe. This protocol conversion is supported by the commonality of the mainframes to interface with a tape drive, but which is supported by the emulation of a tape drive by the queue server 300. Note that if the length of the queue 410 is reduced to having a length of one message, then the protocol conversion from protocol D to protocol A is near real-time.

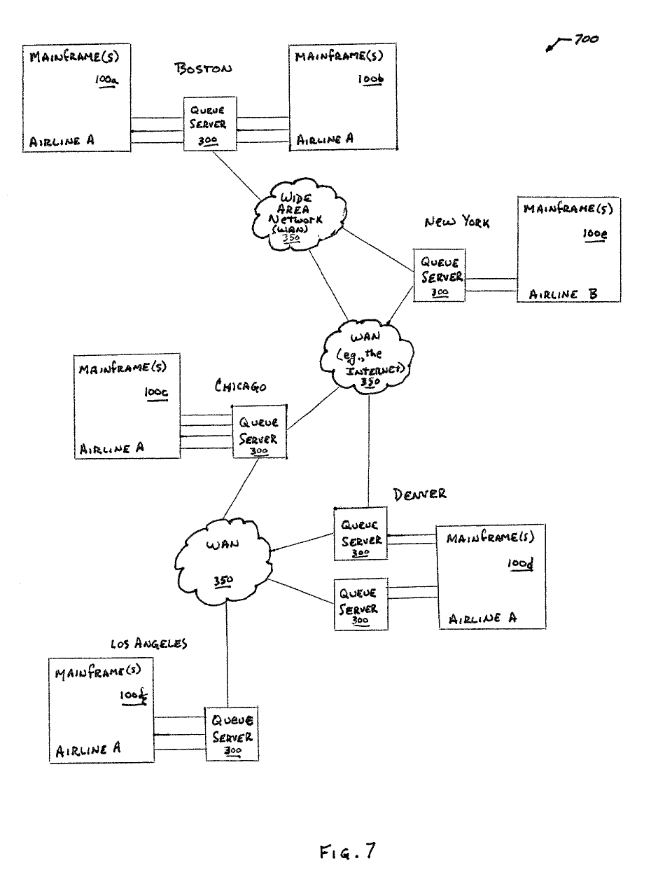

FIG. 7 is a block diagram of an exemplary open network 700 having several queue servers 300 supporting mainframes in various cities about the United States. The application here is an airline, Airline A, that wishes to make its mainframe data available to other mainframes around the country for various offices of airline representatives, agents, and consumers having connections to the open network 700.

In the open network 700, in Boston, Airline A has two mainframes 100a, 100b, connected to a queue server 300. As described above, the mainframes 100a, 100b, can share each other's data through the use of the associated queue server. Similarly, the mainframes 100a, 100b can share data with other mainframes via the queue server 300 and networking middleware 335 (FIG. 3). The queue server 300 is connected to a wide area network 350. The wide area network 350 is connected to another wide area network 350 (e.g., the Internet) and another queue server 300, which is located in New York.

The queue server 300 located in New York supports an associated mainframe 100e, which is owned by Airline B. Airline B, may, for instance, be a subsidiary of Airline A or a business partner, such as an independent, international, airline affiliate. Personnel associated with Airline B may wish to access data from Airline A, such as passenger route information, transaction reports, etc.

Airline A also has a mainframe 100c in Chicago having an associated queue server 300 that provides connections to the wide area network 350, which provides connection to the queue server 300 in New York and distal connection to the queue server 300 in Boston. In this way, personnel in Chicago connected to the Chicago mainframe 100c have access to data in Boston and New York. Similarly, the personnel in Chicago have access to data stored on tapes or in the mainframes located in Denver, mainframe 100d, and Los Angeles, mainframe 100f.

In effect, the queue servers 300 provide protocol-to-protocol conversion between the protocols of operating systems running the mainframes 100a, 100b and network protocols, such as the TCP/IP protocols. Commercial subsystems are used where appropriate (e.g., commercial messaging middleware 335 and TCP/IP interface card 338) within the queue servers 300 so as to have the queue servers 300 be compatible with the latest and/or legacy open systems architectures.

While this invention has been particularly shown and described with references to preferred embodiments thereof, it will be understood by those skilled in the art that various changes in form and details may be made therein without departing from the scope of the invention encompassed by the appended claims.

What is claimed is:

1. Apparatus for protocol conversion, comprising:
a device emulator coupled to a first device having a first protocol;
digital storage coupled to the device emulator for temporary storage of information from the first protocol;
at least one manager (i) coordinating the transfer of the information of the first protocol between the device emulator and the digital storage and (ii) coordinating transfer of the information between the digital storage and a second protocol.

2. The apparatus as claimed in claim 1, wherein the device emulator is a tape drive emulator.

3. The apparatus as claimed in claim 1, wherein the digital storage includes at least one of the following storage devices: magnetic disk, optical disk, and digital memory components.

4. The apparatus as claimed in claim 1, wherein the manager manages input/output data between a mainframe computer and a commercial queuing system.

5. The apparatus as claimed in claim 4, further including a group driver (i) supporting at least one pseudo-tape driver and (ii) interfacing with the digital storage.

6. The apparatus as claimed in claim 1, further including a second device emulator coupled to the digital storage, wherein said at least one manager coordinates transfer of information between the two device emulators.

7. The apparatus as claimed in claim 1, used in a wide area network to share data among multiple device emulators and at least two protocols.

8. The apparatus as claimed in claim 1, used to transfer data between or among multiple mainframe computers.

9. The apparatus as claimed in claim 1, wherein the information is arranged in a queue in the digital storage.

10. A method for protocol conversion, comprising:
emulating a peripheral device to receive information from a first computer having a first protocol;
temporarily storing the information;
coordinating the transfer of the temporarily stored information having a first protocol to a second computer having a second protocol in a manner causing the information to take on characteristics of the second protocol.

11. The method as claimed in claim 10, wherein said emulating includes emulating a tape drive.

12. The method as claimed in claim 10, wherein storing the information includes writing the information to at least one of the following storage devices: magnetic disk, optical disk, and digital memory components.

13. The method as claimed in claim 10, wherein said coordinating the transfer of the temporarily stored information includes managing input/output data between a mainframe computer and a commercial queuing system.

14. The method as claimed in claim 13, further including directing the information from the first computer to a digital storage area used to temporarily store the information.

15. The method as claimed in claim 10, further including emulating a second peripheral device and coordinating transfer of information between the first computer and the second computer separated by temporarily storing the information.

16. The method as claimed in claim 10, used in a wide area network to share data among multiple computers using multiple protocols.

17. The method as claimed in claim 10, used to transfer data between or among multiple mainframe computers.

18. The method as claimed in claim 10, wherein the temporarily stored information is arranged in a queue.

19. In an apparatus for protocol conversion, a manager having distributed components, comprising:
at least one I/O manager having intelligence to support states of (i) emulation devices transceiving messages using a first protocol and (ii) an interface transceiving messages using a second protocol;
at least one emulation device providing low-level control reaction to an external device adhering to the first protocol; and
at least one group driver to provide an interface between the I/O manager and said at least one emulation device.

20. The manager as claimed in claim 19, wherein said at least one group driver buffers data to allow for direct memory access (DMA) transfer.

21. The manager as claimed in claim 19, wherein said at least one emulation device emulates at least one tape drive.

22. The manager as claimed in claim 19, wherein the I/O application includes multiple input/output managers.

23. The manager as claimed in claim 19, wherein the manager includes a sufficient number of emulation devices, group drivers, and I/O managers to maximize parallel processing performance of protocol conversion.

24. A method for protocol conversion, comprising:
using an I/O manager, transceiving messages with at least one first external device using a first protocol;
using the I/O manager, transceiving the same messages with at least one second external device using a second protocol;
emulating low-level control reactions to support the transceiving of the messages with the first external device in a manner that disassociates the I/O manager from the low-level control reactions; and
channeling data flow between the I/O manager and said at least one first external device in a manner that minimizes interfacing by the I/O manager with said at least one first external device.

25. The method as claimed in claim 24, further including buffering data to allow for direct memory access (DMA) transfers.

26. The method as claimed in claim 24, wherein said emulating low-level control reactions is performed in a manner similar to that of a tape drive.

27. The method as claimed in claim 24, further including channeling multiple data flows simultaneously by employing multiple I/O managers.

28. The method as claimed in claim 24, further including a plurality of transceiving, emulating and channeling steps in a parallel manner to maximize parallel processing performance of the protocol conversion.

29. Apparatus for mainframe-to-mainframe connectivity, comprising:
a first device emulator in communication with a first mainframe and acting as a standard sequential storage device;
a second device emulator in communication with a second mainframe and also acting as a standard sequential storage device;
digital storage coupled to the first and second device emulators to store information temporarily for the first and second device emulators; and
at least one manager (i) coordinating a first transfer of information between the first device emulator and the digital storage and (ii) coordinating a second transfer of information from the digital storage to the second device emulator, the first and second mainframes having access to the information via respective device emulators.

30. The apparatus as claimed in claim 29, wherein the information stored in the digital storage is arranged in a queue.

31. The apparatus as claimed in claim 30, wherein the length of the queue is short to approach real-time protocol conversion.

32. The apparatus as claimed in claim 30, wherein said manager dynamically adjusts the length of the queue.

33. The apparatus as claimed in claim 29, further including a queue manager to support a case in which the first and second mainframes are not synchronized when transferring information via the apparatus.

34. The apparatus as claimed in claim 29, wherein the second device emulator communicates with a second device emulator of a remote apparatus to transfer the information over a data network to provide remote connectivity between the first and second mainframes.

35. A method for providing mainframe-to-mainframe connectivity, comprising:
assigning a first digital memory region external from a first mainframe to store messages in a sequential order for the first mainframe;
assigning a second digital memory region external from a second mainframe to store messages in a sequential order for the second mainframe;
emulating a device capable of communicating with the first and second mainframes to respond to requests from at least one of the mainframes; and
in response to a request from at least one of the mainframes, establishing a link between the first and second digital memory regions to provide effective mainframe-to-mainframe connectivity between the first and second mainframes.

36. The method as claimed in claim 35, further including storing messages from the mainframes in the digital memory region in a queue arrangement.

37. The method as claimed in claim 36, wherein the length of the queue is short to approach real-time protocol conversion.

38. The method as claimed in claim 36, further including dynamically adjusting the length of the queue.

39. The method as claimed in claim 35, further including managing the queue to support a case in which the first and second mainframes are not synchronized when transferring information between the first and second mainframes.

40. The method as claimed in claim 35, wherein emulating a device includes communicating with a remote process also emulating a device to transfer the information over a data network to provide remote connectivity between the first and second mainframes.

41. In a data storage system, a method for managing messages, comprising:
receiving information that is normally contained in a standard tape label;
based on the information, applying the information to a non-tape memory designated for a message queue;
storing messages related to the information in the memory; and
managing the message queue as a function of the standard tape label information.

42. The method as claimed in claim 41, wherein the information normally contained in a standard tape label includes at least one of the following elements: volume serial number, data set name, expiration date, security attributes, and data characteristics.

43. The method as claimed in claim 42, further including creating a queue name based on the volume serial number and data set name.

44. The method as claimed in claim 42, further including deciding how long to maintain the message queue based on the expiration date.

45. The method as claimed in claim 42, further including securing the message queue based on the security attributes.

46. The method as claimed in claim 42, further including optimizing the message queue based on the data characteristics.

47. The method as claimed in claim 42, further including mounting the message queue based on the volume serial number or data set name in response to receiving a request for either.

48. Apparatus for managing messages, comprising:
a receiver to receive information from a computer that is normally contained in a standard tape label; and
a controller that (i) applies the information to a non-tape memory, designated for a message queue, (ii) stores messages related to the information in the memory, (iii) manages the message queue as a function of the standard tape label information.

49. The apparatus as claimed in claim 48, wherein the information normally contained in a standard tape label includes at least one of the following elements: volume serial number, data set name, expiration date, security attributes, and data characteristics.

50. The apparatus as claimed in claim 49, wherein the controller creates a queue name based on the volume serial number and data set name.

51. The apparatus as claimed in claim 49, wherein, based on the expiration date, the controller decides how long to maintain the message queue.

52. The apparatus as claimed in claim 49, wherein, based on the security attributes, the controller secures the message queue.

53. The apparatus as claimed in claim 49, wherein, based on the data characteristics, the controller optimizes the message queue.

54. The apparatus as claimed in claim 49, wherein the controller mounts the message queue based on the volume serial number or data set named in response to receiving a request for either.

55. Apparatus for protocol conversion, comprising:
means for interfacing with a computer having legacy applications;
means for interfacing with an open system network;
means for emulating a sequential storage device in a manner supported by the legacy applications;
means for storing data being transferred between the computer and devices coupled to the open system network, said means for storing data interacting with said means for emulating a sequential storage device; and
means for providing the computer and devices access to the stored data.
